(19) United States
(12) Patent Application Publication
(10) Pub. No.: US 2021/0002029 A1
(43) Pub. Date: Jan. 7, 2021

(54) CONTAINER WITH GRIP

(71) Applicant: PopSockets LLC, Boulder, CO (US)

(72) Inventor: David B. Barnett, Boulder, CO (US)

(21) Appl. No.: 16/937,087

(22) PCT Filed: Dec. 18, 2018
(86) PCT No.: PCT/US2018/066130

§ 371 Date: Jul. 23, 2020

Related U.S. Application Data
(60) Provisional application No. 62/621,943, filed on Jan. 25, 2018.

(51) Int. Cl. B65D 23/10; B65D 23/08; B65D 1/02; A45F 3/18; A47G 23/02

(52) U.S. Cl. CPC B65D 23/104; B65D 23/0842; A47G 23/0216; A45F 3/18; B65D 1/0223

(57) ABSTRACT

A container assembly for holding a beverage includes a walled container having an interior surface and an exterior surface. An expandable grip accessory is operatively coupled to the walled container and includes a grip accessory body movable between an extended configuration and a collapsed configuration. The grip accessory body includes a first end and a second end. A hub is operatively coupled to the walled container and includes an opening sized to receive at least a portion of the second end of the grip accessory body. The first end of the grip accessory body is spaced away from the exterior surface of the walled container when the grip accessory body is in the extended configuration.

### CROSS-REFERENCE TO RELATED APPLICATION

Priority is claimed to U.S. Provisional Application No. 62/621,943, filed Jan. 25, 2018, the entire contents of which are incorporated herein by reference.

### FIELD OF DISCLOSURE

The present disclosure relates generally to containers for holding a beverage or for holding a container holding a beverage and, more particularly, to a container assembly or container sleeve incorporating an expandable grip accessory.

### BACKGROUND

Expandable grip accessorys may be attached directly to a portable electronic device or to a case protecting the device. They are used for a variety of functions, including propping the device on a surface and providing an expandable grip for handling the device. The expandable grip accessorys have decorative buttons, which may display logos, decals, symbols, or other artistic renderings.

### SUMMARY

In accordance with a first exemplary aspect, a container assembly for holding a beverage may include a walled container having an interior surface and an exterior surface. The interior surface may at least partially define a reservoir for holding a liquid or a container for holding a liquid. An expandable grip accessory may be operatively coupled to the walled container. The expandable grip accessory may include a grip accessory body movable between an extended configuration and a collapsed configuration. The grip accessory body may include a first end and a second end. A hub may be operatively coupled to the walled container. The hub may include an opening sized to receive at least a portion of the second end of the grip accessory body. The first end of the grip accessory body may be spaced away from the exterior surface of the walled container when the grip accessory body is in the extended configuration.

In accordance with a second exemplary aspect, a sleeve for holding a beverage container may include a body having a cavity, a longitudinal axis, a first surface, and a second surface. The first surface may at least partially define the cavity. An expandable grip accessory may be operatively coupled to the body. The expandable grip accessory may include a grip accessory body movable between an extended configuration and a collapsed configuration. The grip accessory body may be expandable in a direction substantially perpendicular relative to the longitudinal axis of the body.

In further accordance with any one or more of the first and second exemplary aspects, the container assembly and/or sleeve may include any one or more of the following forms.

In a preferred form, the second end of the grip accessory body may be removably coupled to the hub.

In a preferred form, the hub may include a first surface and a second surface. The first surface may define the opening and the second surface may be deformable to fit against the exterior surface of the walled container.

In a preferred form, the second surface may be curved to conform to the exterior surface of the walled container.

In a preferred form, the hub may be removably attached to the exterior surface of the walled container.

In a preferred form, an indentation may be formed in the exterior surface of the walled container, the indentation sized to receive at least a portion of the expandable grip accessory.

In a preferred form, the hub may be at least partially embedded within the walled container such that a portion of the hub is disposed between the interior surface and the exterior surface of the walled container.

In a preferred form, the hub may be integrally formed with the exterior surface of the walled container.

In a preferred form, a sleeve may be connected to the hub. The sleeve may include an outer surface, an inner surface, and a cavity at least partially defined by the inner surface. The cavity may be sized to receive at least a portion of the walled container.

In a preferred form, an aperture may extend through the outer surface and inner surface of the sleeve. The aperture may be sized to receive at least a portion of the grip accessory body.

In a preferred form, the hub may be disposed between the exterior surface of the walled container and the inner surface of the sleeve.

In a preferred form, the aperture of the sleeve may define a stepped profile to receive the grip accessory body when the expandable grip accessory is in the collapsed configuration.

In a preferred form, hub may be integrally formed with the outer surface of the sleeve.

In a preferred form, the hub may couple to the second end of the grip accessory body by snap fit connection.

In a preferred form, the walled container may be a sleeve and may be connected to the hub. The sleeve may include a cavity at least partially defined by the interior surface. The cavity may be sized to receive a container for holding a beverage.

In a preferred form, the grip accessory body may extend through an aperture formed in the walled container and the hub may include a first surface forming the opening and a second surface. A portion of the first surface may be adjacent to the interior surface of the walled container.

In a preferred form, a hub may be operatively coupled to the grip accessory body and the grip accessory body may include a second end. The hub may include an opening sized to receive at least a portion of the second end of the grip accessory body.

In a preferred form, the hub may include a first surface and a second surface. The first surface may define the opening and the second surface may have a radius of curvature sized substantially similar to a radius of curvature of the first surface of the body.

In a preferred form, the hub may be at least partially embedded within the body such that a portion of the hub is disposed between the first surface and the second surface of the body.

In a preferred form, the hub may be removably attached to the body.

In a preferred form, the hub may be integrally formed with the body.

In a preferred form, the body may include an aperture formed through the first surface and the second surface of the body. The hub may be disposed within the cavity and may extend at least partially through the aperture.

In a preferred form, the body may include an indentation formed in the second surface and sized to receive at least a portion of the grip accessory body.

In a preferred form, the body may include a first half, a second half, and a hinge pivotably connecting the first half and the second half.

### BRIEF DESCRIPTION OF THE DRAWINGS

The features of this invention which are believed to be novel are set forth with particularity in the appended claims. The invention may be best understood by reference to the following description taken in conjunction with the accompanying drawings, in which like reference numerals identify like elements in the several Figures, in which:

FIG. 1 is a side view of a first exemplary container assembly having a first exemplary expandable grip accessory constructed in accordance with the teachings of the present disclosure, the expandable grip accessory in a collapsed configuration;

FIG. 2 is a side view of the container assembly of FIG. 1, the expandable grip accessory in an extended configuration;

FIG. 3 is a side view of a first exemplary container assembly including a sleeve constructed in accordance with the teachings of the present disclosure, the container assembly including the first exemplary expandable grip accessory of FIG. 1 in the collapsed configuration;

FIG. 4 is a side view of the sleeve of FIG. 3, the expandable grip accessory in an extended configuration;

FIG. 5 is a partial side cross-sectional view of a hub and the expandable grip accessory of FIGS. 1-4 in the collapsed configuration;

FIG. 6 is a front view of a second exemplary container assembly including a sleeve with a second exemplary expandable grip accessory constructed in accordance with the teachings of the present disclosure;

FIG. 7 is a partial side cross-sectional view of the container assembly of FIG. 6, the expandable grip accessory in a collapsed configuration;

FIG. 8 is a front view of a third exemplary container assembly including a third exemplary expandable grip accessory constructed in accordance with the teachings of the present disclosure;

FIG. 9 is a side view of the container assembly of FIG. 8, the expandable grip accessory in a collapsed configuration;

FIG. 10 is a side view of the container assembly of FIG. 8, the expandable grip accessory in an expanded configuration;

FIG. 11 is a front view of a third container assembly including a sleeve constructed in accordance with the teachings of the present disclosure, the sleeve including the third exemplary expandable grip accessory of FIG. 8;

FIG. 12 is a partial side cross-sectional view of the container assembly of FIG. 8;

FIG. 13 is a partial top cross-sectional view of the container of FIG. 8;

FIG. 14 is a partial top cross-sectional view of a container or a sleeve of a fourth exemplary container assembly constructed in accordance with the teachings of the present disclosure;

FIG. 15 is a partial side cross-sectional view of a container or a sleeve of a fifth exemplary container assembly and a fourth exemplary expandable grip accessory constructed in accordance with the teachings of the present disclosure, the expandable grip accessory in an extended configuration;

FIG. 16 is a partial side cross-sectional view of a container or a sleeve of a sixth exemplary container assembly and the third exemplary expandable grip accessory of FIG. 8 constructed in accordance with the teachings of the present disclosure, the expandable grip accessory in a collapsed configuration;

FIG. 17 is a perspective view of a seventh container assembly including a sleeve holding the first exemplary container assembly of FIG. 1 constructed in accordance with the teachings of the present disclosure, the expandable grip accessory in an extended configuration;

FIG. 18 is an eighth exemplary container assembly including a sleeve and the third exemplary expandable grip accessory of FIG. 8 constructed in accordance with the teachings of the present disclosure, the expandable grip accessory in a collapsed configuration;

FIG. 19 is a ninth exemplary container assembly including a sleeve and a fifth exemplary expandable grip accessory constructed in accordance with the teachings of the present disclosure, the sleeve holding a portion of a stemmed container and the expandable grip accessory in an extended configuration; and

FIG. 20 is a side view of a tenth exemplary container assembly including a pocket for holding a portable media player and an expandable grip accessory constructed in accordance with the teachings of the present disclosure, the expandable grip accessory in a collapsed configuration.

### DETAILED DESCRIPTION

A container assembly for holding a beverage constructed in accordance with the teachings of the present disclosure may provide an expandable and collapsible grip that may be incorporated into a container wall or a sleeve of a container. The grip may be stored in a collapsed configuration when not in use, and may sit flush against the wall of the container or sleeve or it may extend away from the container or sleeve to provide a knob for storing earbuds. In some instances, the grip of the current disclosure may include, at least in part, an extending grip accessory as disclosed in U.S. Pat. No. 8,560,031 and U.S. Publication No. 2018/0288204, the entire disclosures of which are incorporated herein by reference. In some examples, the grip, hereinafter referred as an expandable grip accessory, of the container assembly may be adapted to removably couple from the container or sleeve and attach to a portable media player or other device.

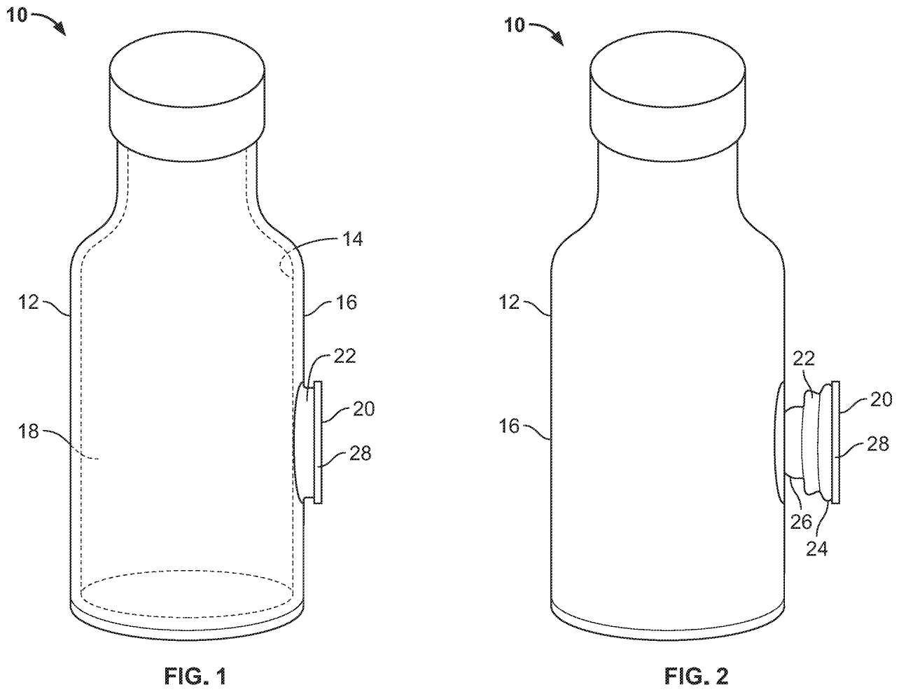

In FIGS. 1 and 2, a first exemplary container assembly 10 for holding a beverage is constructed in accordance with the teachings of the present disclosure. A walled container 12, which in the illustrated example is a bottle, includes an interior surface 14 and an exterior surface 16, where the interior surface at least partially defines a reservoir 18 for holding a liquid or other substance. An expandable grip accessory 20 is operatively coupled to the walled container 12 and is expandable between a collapsed configuration, as shown in FIG. 1, and an extended configuration, as shown in FIG. 2. The expandable grip accessory 20 includes a grip accessory body 22 having a flexible wall that folds on itself when in the collapsed configuration, and expands to a tapered conical shape when fully extended. The expandable grip accessory 20 may include an extending grip accessory as disclosed in U.S. Pat. No. 8,560,031. In the collapsed configuration, the grip accessory body 22 is folded so that the expandable grip accessory 20 has a reduced volume. The grip accessory body 22 can take the form of an accordion shaped cover structure made of a deformable and durable material. The accordion-shaped cover structure includes a folding portion that includes a plurality of relatively rigid walls interspersed with flexural (or “living”) hinges. A plurality of vents are formed through the folding portion of the grip accessory 22 body to facilitate collapsing and expanding of the body 22 between the collapsed configuration and the expanded configuration, and a plurality of intermediary configurations between the collapsed and expanded configurations. The grip accessory body 22 includes a first end 24 coupled to a removable button 28 and a second end 26 coupled to the walled container 12. The folding portion is disposed between the first end 24 and the second end 26 of the grip accessory body 22, and is symmetrical about a longitudinal axis of the grip accessory body. As shown in FIG. 2, the first end 24 of the grip accessory body 22 is spaced away from the exterior surface 16 of the walled container 12 when the grip accessory body 22 is fully extended. In the illustrated example of FIGS. 1 and 2, the walled container 12 is a bottle, such as a water bottle, but may be any walled container, such as, for example, a travel mug, a tumbler, a drink sleeve, a koozie, or other reusable vessel. In yet other examples, the walled container may be a disposable bottle or can.

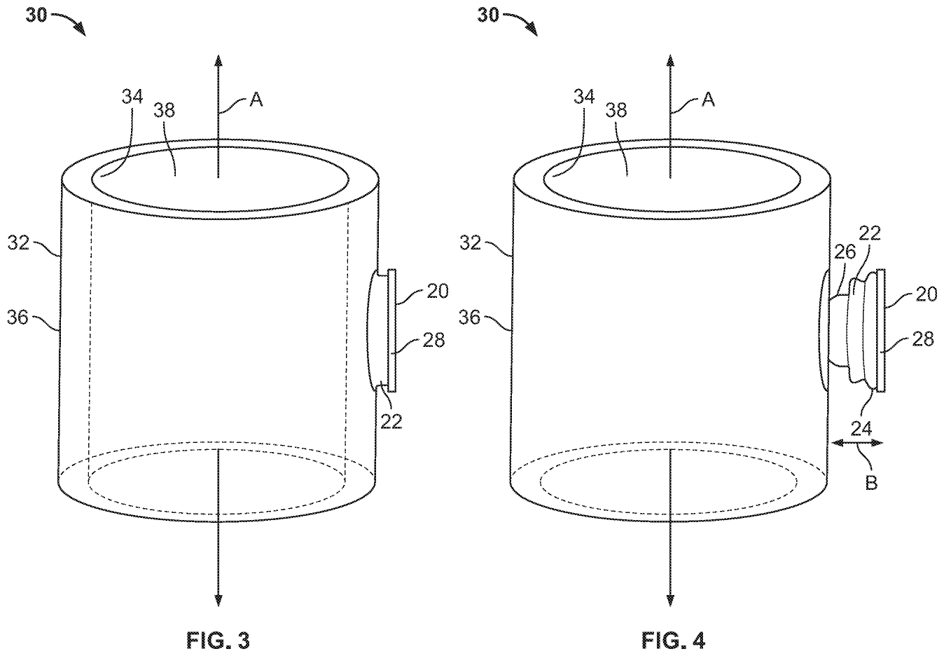

In FIGS. 3 and 4, a first exemplary container assembly 30 with a different walled container 32 is constructed according the teachings of the present disclosure. The walled container 32 is a sleeve and includes an interior surface 34 and an exterior surface 36 where the interior surface 34 at least partially defines a cavity 38 for holding a container which holds a liquid or other substance. The sleeve 32 may be a fabric, foam, silicone, or plastic wrapped container that is sized to receive a bottle, can, coffee cup, or other beverage container. In the illustrated example, the sleeve 32 has a cylindrical body and is symmetrical about a longitudinal axis A. An expandable grip accessory 20, which may be the same or different than the expandable grip accessory 20 of FIGS. 1 and 2, is operatively coupled to the walled container 32 and is expandable in a direction B, which is substantially perpendicular relative to the longitudinal axis A. When the expandable grip accessory 20 is in the collapsed configuration, the expandable grip accessory 20 protrudes from the exterior surface 36 of the walled container 32, and provides adequate space between the exterior surface 36 of the sleeve 32 and the button 28 to permit a user to grip the expandable grip accessory 20 or to wrap earbud wires around the grip accessory body 22 for storage. While the illustrated walled containers 12, 32 of FIGS. 1-4 are cylindrical, other examples of walled containers may be rectangular to hold a juice box, a square carton or bottle, or other shapes to hold irregular or non-cylindrical containers. The walled containers 12, 32 may include grooves formed in the exterior surfaces 16, 36 for additional finger grips or to display brand designs.

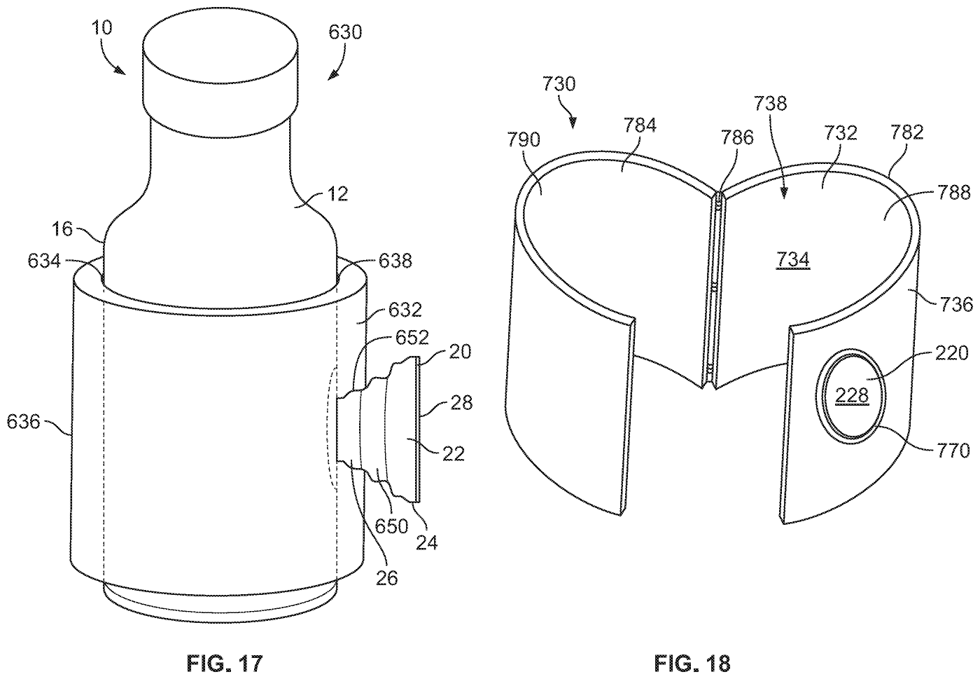

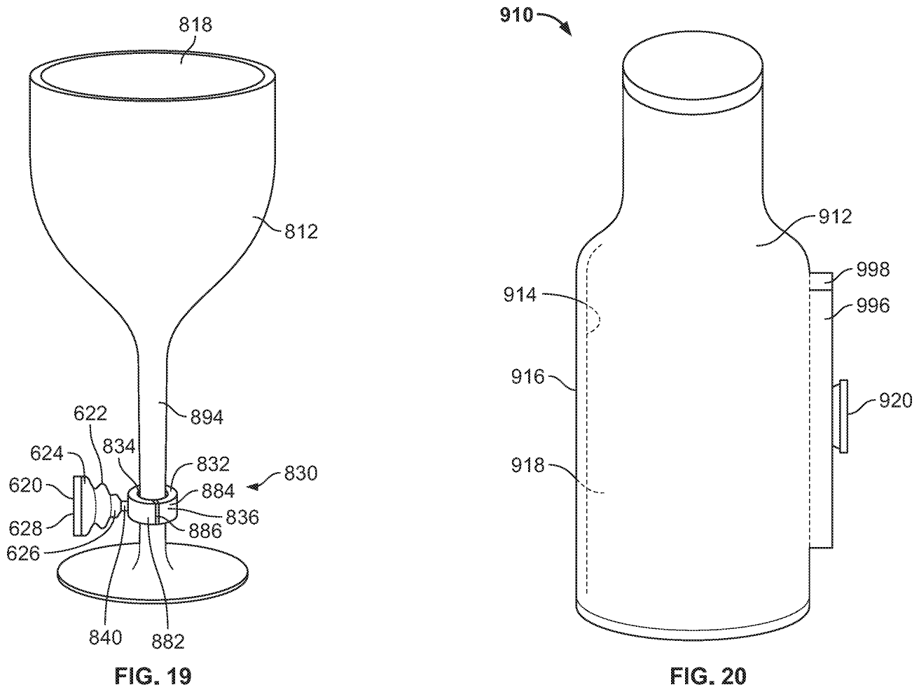

As used herein, “walled container” may refer to any container such as, for example, a sleeve, bottle, or body depending on the particular example being described. For instance, the walled container 12 of FIGS. 1 and 2 is in the form of a bottle, but may be a different type of container. The walled container 32 of FIGS. 3 and 4 is in the form of a sleeve, which may be configured to hold a beverage or hold a container, like a bottle. In some examples, a first walled container may be coupled to a second walled container (e.g. FIGS. 17, 19).

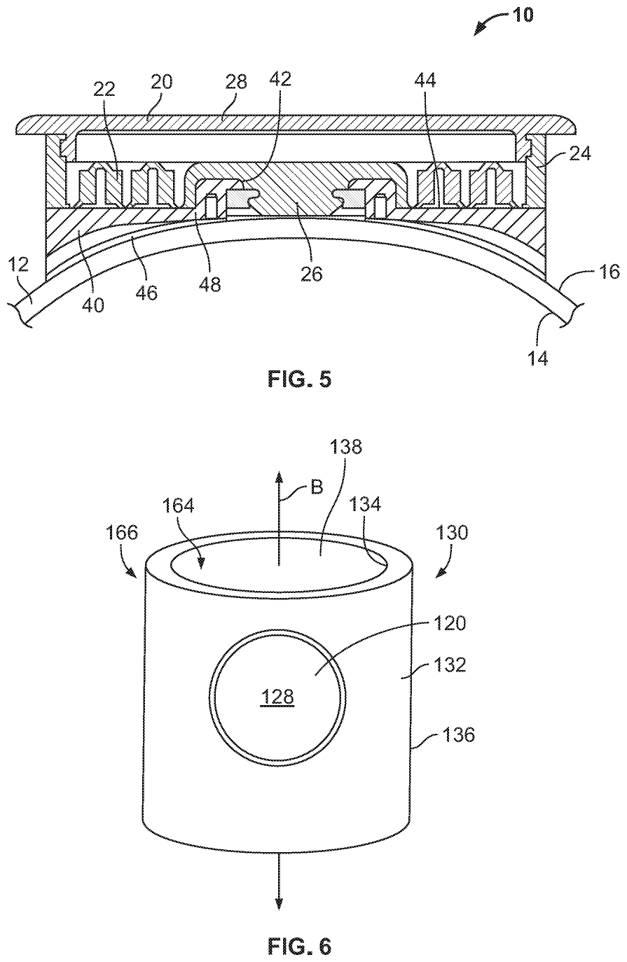

In the first exemplary arrangement of the container assembly 10, the expandable grip accessory 20 may be operatively coupled to the outer surface 16 of the walled container 12 by a hub 40. In other versions, the grip accessory 20 may be coupled directly to the container 12 without a hub 40. FIG. 5 illustrates a cross-section of the container assembly 10 of FIGS. 1 and 2. However, the cross-section of FIG. 5 may be substantially identical to a cross-section of the container assembly 30 of FIGS. 3 and 4. In the depicted version, the hub 40 is operatively coupled to the walled container 12 and includes an opening 42 sized to receive at least a portion of the second end 26 of the grip accessory body 22. The hub 40 includes a first surface 44 that defines the opening 42 of the hub 40 and a second surface 46 that is adapted to sit flush against (i.e., conform to) the exterior surface 16 of the walled container 12. The second surface 46 of the hub 40 can be deformable to fit against the exterior surface 16 of the walled container 12 such that the hub 40 may be operatively coupled (e.g. attached, fixed, etc.) to the walled container 12 in any orientation and also to walled containers of differing contours. As shown in FIG. 5, the second surface 46 is curved to conform to an outer circumference of the walled container 12 and may have a radius of curvature substantially similar to a radius of curvature of the exterior surface 16 of the walled container 12. The second surface 46 of the hub 40 may adhere to the exterior surface 16, 36 of either walled container 12, 32 by friction, suction, adhesive permanently, or temporarily (i.e. removably attached) through the application of reusable adhesives or similar materials suitable for the intended purpose. For example, the second surface 46 of the hub 40 may be made of suction cup tape to securely attach to many different types of containers. In other examples, the expandable grip accessory 20 may be operatively coupled to the walled container 12 directly, indirectly, via a hub, a sleeve, or other suitable mechanisms.

The hub 40 is also removably coupled to the expandable grip accessory 20 so that the expandable grip accessory 20 may be replaced without removing the hub 40 from the walled container 12. In the illustrated example, the opening 42 of the hub 40 is sized to slidably receive the second end 26 of the expandable grip accessory 20. The opening 42 is formed in a collar 48, which extends away from the first surface 44 of the hub. The opening 42 is adapted to slidably receive and connect with the second end 26 of the grip accessory body 22. In another example, the opening 42 may shaped to receive a male snap-fit connector such that the collar 48 may slightly deform to receive the grip accessory body 22 in snap-fit connection. In some instances, the hub 40 and grip accessory body 22 of the present disclosure may include a coupling mechanism as disclosed in U.S. application Ser. No. 15/864,509, filed Jan. 8, 2018, and U.S. application Ser. No. 15/864,402, filed Jan. 8, 2018, the entire disclosures of which are incorporated herein by reference. The hub 40 and expandable grip accessory 20 are configured to attach to any container 12 and may be removed from the walled container 12 before the walled container 12 is recycled or trashed.

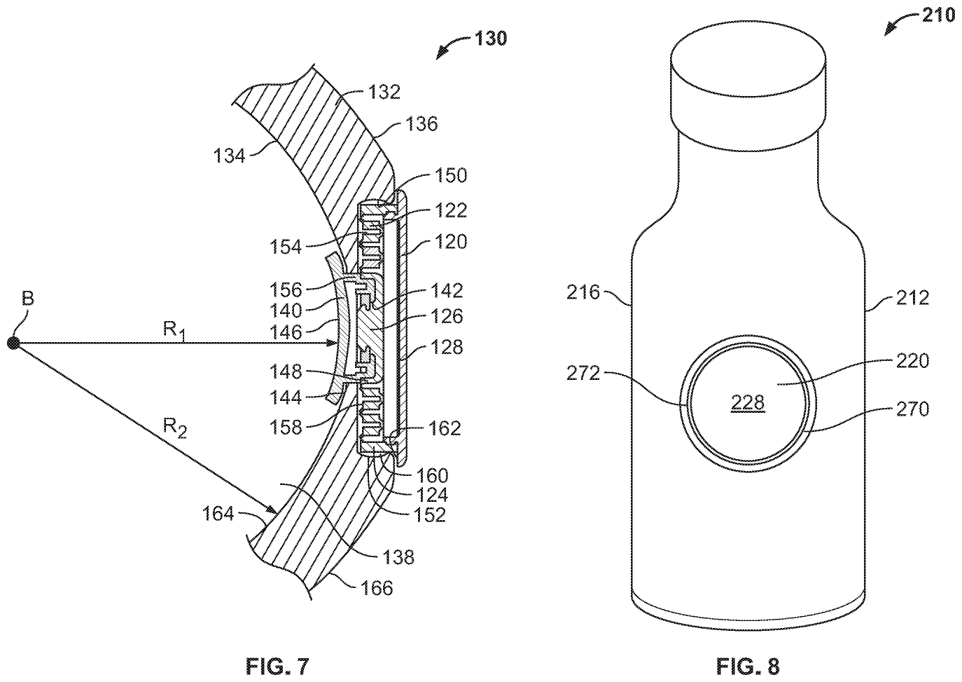

In FIGS. 6 and 7, a second exemplary container assembly 130 is assembled in accordance with the teachings of the present disclosure. A sleeve 132 of the container assembly 130 is similar to the sleeve 32 of the first exemplary container assembly 30 of FIGS. 3 and 4 described above, except that a second exemplary expandable grip accessory 120 of the second exemplary container assembly 130 is at least partially embedded with the walled container 132 (i.e. the sleeve). Elements of the container assembly 130 in FIGS. 6 and 7 which are similar to the elements of the container assembly 30 of FIGS. 3 and 4 are designated by the same reference numeral, incremented by 100. A description of many of these elements is abbreviated or even eliminated in the interest of brevity. Further, the second exemplary expandable grip accessory 120 is similar to the first exemplary expandable grip accessory 20 of FIGS. 1-5, except that the second exemplary expandable grip accessory 120 couples to the walled container 132 differently. Thus, elements of second exemplary expandable grip accessory 120 which are similar to the elements of the first exemplary expandable grip accessory 20 of FIG. 1-5 are designated by the same reference numeral, incremented by 100, as well.

In the second exemplary arrangement of FIGS. 6 and 7, the container assembly 130 includes the expandable grip accessory 120 operatively coupled to the walled container 132. As illustrated in FIG. 7, the expandable grip accessory 120 is at least partially embedded in the walled container 132 of the container assembly 130. The walled container 132 includes an aperture 150 extending through an exterior surface 136 and an interior surface 134 of the sleeve 132 and is sized to receive a portion of a grip accessory body 122 of the expandable grip accessory 120. The aperture 150 includes a stepped profile 152 such that the grip accessory body 122 fits within a recessed portion 154 of the walled container 132 while a button 128 of the expandable grip accessory 120 is disposed adjacent to the exterior surface 136. The stepped profile 152 formed in the walled container 132 is specifically constructed to receive the grip accessory body 122 when the grip accessory body 122 is folded in the collapsed configuration. In this way, the expandable grip accessory 120 is substantially flush with the walled container 132 of the container assembly 130, and may not increase the overall thickness of the walled container 132. In this example, the arrangement of the expandable grip accessory 120 relative to the walled container 132 reduces the chance of catching the button 128 or grip accessory body 122 when slipping the container assembly 130 into a backpack or bag.

The stepped profile 152 of the walled container 132 permits the expandable grip accessory 120 to nest within the recessed portion 154 for storing the expandable grip accessory 120. The stepped profile 152 is defined in part by a neck 156, a shoulder 158, a vertical portion 160, and the recessed portion 154 radially disposed inward relative to the exterior surface 136 of the walled container 132. The shoulder 158 supports the expandable grip accessory 120 in the collapsed configuration, and is partially defined by the recessed portion 154 of the aperture 150. The neck 156 is sized to snugly fit against a collar 148 of a hub 140, holding the hub 140 in place when the hub 140 is operatively coupled to the walled container 132. The collar 148 extends through the aperture 150 and into the recessed portion 154 to couple a second end 126 of the grip accessory body 122 to an opening 142 of the hub 140. The vertical portion 160 of the sleeve 132 extends from the shoulder 158 and encircles a first end 124 of the grip accessory body 122 in the collapsed configuration. The button 128 of the expandable grip accessory 120 extends slightly beyond the exterior surface 136 of the walled container 132 and outside of the recessed portion 154 when the expandable grip accessory 120 is in the collapsed configuration. As shown in the illustrated example, a bottom surface 162 of the button 128 rests against the exterior surface 136 of the walled container 132.

In this particular example, the hub 140 of the second exemplary container assembly 130 is suited for a sleeved container 132. Similar to the hub 40 of the first exemplary assembly 10, the hub 140 is operatively coupled to the grip accessory body 122 and includes the collar 148 defining the opening 142 to receive the second end 126 of the grip accessory body 122. Unlike the previous example, the collar 148 of the hub 140 extends at least partially through the aperture 150 of the sleeve 132. A first surface 144 of the hub 140 is curved to sit flush against the interior surface 134 of the sleeve 132 and a second surface 146 is curved to sit flush against an exterior surface of a beverage container. The second surface 146 of the hub 140 may be deformable so that the hub 140 is adapted to conform to an exterior surface of any beverage container, or the second surface 146 may be molded to fit against an exterior surface of a particular beverage container. For example, the second surface 146 of the hub 140 has a radius of curvature R1 sized substantially similar to a radius of curvature R2 of the interior surface 134 of the walled container 132. Thus, the second surface 146 of the hub 140 may adequately form around the exterior surface of any container that is disposed within a cavity 138 of the sleeve 136.

Generally, a user of the container assembly 130 of FIGS. 6 and 7 may assemble the container assembly 130 by operatively coupling the hub 140 to the expandable grip accessory 120 by inserting the hub 140 through the aperture 150 from an interior side 164 of the sleeve 132 and snapping the collar 148 between the neck 156 of the sleeve 132. The user may simultaneously insert the second end 126 of the grip accessory body 122 into the recessed portion 154 of the aperture 150 from an exterior side 166 of the sleeve 132. The user may then slide, rotate, or snap the second end 126 of the grip accessory body 122 into the opening 142 of the hub 140. In another example, the user may first couple the hub 140 and expandable grip accessory 120 together before pushing either the expandable grip accessory 120 or hub 140 through the aperture 150, either by rotating, twisting, or angling the expandable grip accessory 120 and hub 140 relative to the aperture 150. The sleeve 132 may be made of a pliable material to permit the hub 140 or the expandable grip accessory 120 to fit through the aperture 150 without permanently deforming the sleeve 132. After the container assembly 130 is in place, the user may dispose a beverage container, such as a can or a bottle, within the cavity 138 defined by the sleeve 132.

In some examples, a hub of a container assembly may be embedded or partially embedded with a walled container. A male or female connecting member may protrude slightly from an exterior surface of the walled container to removably couple to an expandable grip accessory. In the following examples, a hub may be integrally formed with a walled container so that an expandable grip accessory attaches directly to the walled container.

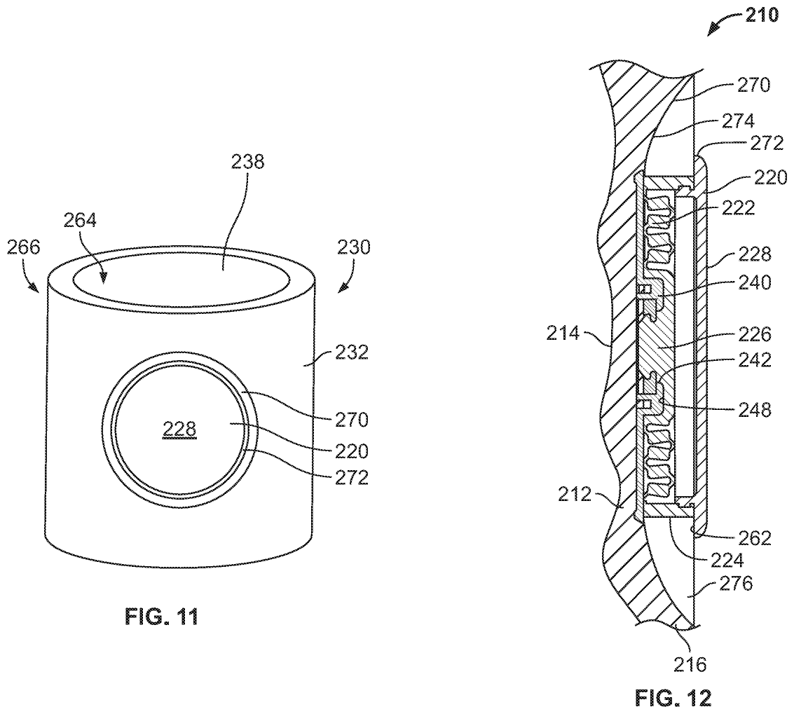

Turning to FIGS. 8-10 and FIG. 11, a third exemplary container assembly 210, 230 including a bottle 212 and a sleeve 232, respectively, are constructed in accordance with the teachings of the present disclosure. In FIG. 8, the third exemplary container assembly 210 is similar to the first exemplary container assembly 10 of FIGS. 1 and 2 described above, except that a third exemplary expandable grip accessory 220 is at least partially embedded within the walled container 212. Elements of the container assembly 210 in FIG. 8 which are similar to the elements of the container assembly 10 of FIGS. 1 and 2 are designated by the same reference numeral, incremented by 200. A description of many of these elements is abbreviated or even eliminated in the interest of brevity. Likewise, the third exemplary expandable grip accessory 220 is similar to the first exemplary expandable grip accessory of FIGS. 1-5, except that the expandable grip accessory 220 couples to the walled container 212 differently. Thus, elements of third exemplary expandable grip accessory 220 of FIG. 8 which are similar to the elements of the first exemplary expandable grip accessory 20 are designated by the same reference numeral, incremented by 200. Further, elements of the third exemplary container assembly 230 with the sleeve 232 of FIG. 11 which are similar to the elements of the second exemplary container assembly 130 are designated by the same reference numeral, incremented by 100.

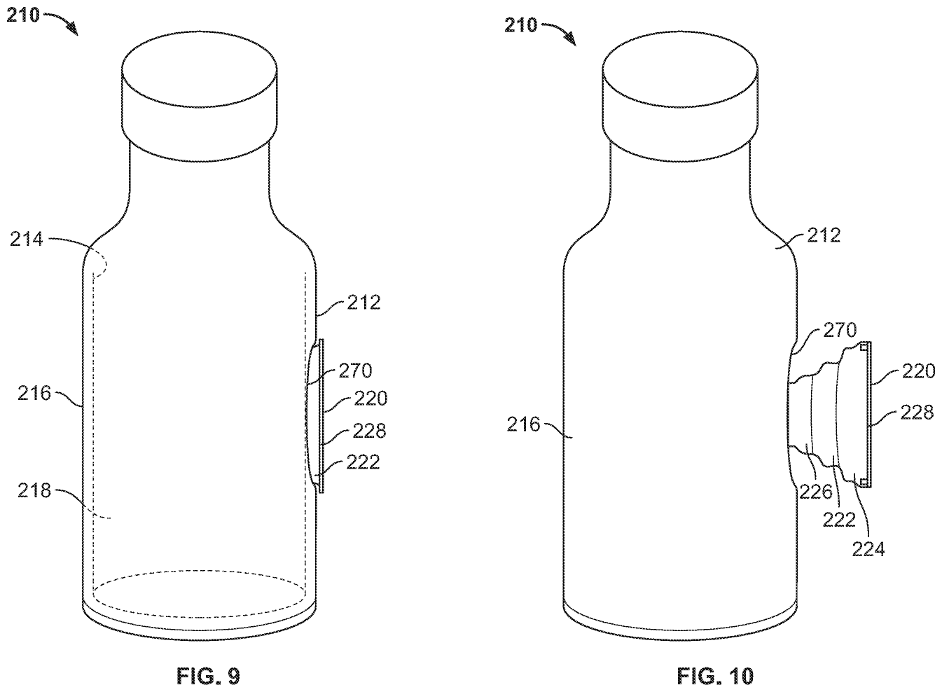

The third container assembly 210 is constructed so that the expandable grip accessory 220 is flush with an exterior surface 216 of the walled container 212. As shown in FIG. 8, an indent 270 surrounds an outer circumference 272 of a button 228 of the expandable grip accessory 220. The indent 270 provides a recessed area such that a user may grip the expandable grip accessory 220 and pull the expandable grip accessory 200 from a collapsed configuration, as shown in FIG. 9, to the extended configuration, as shown in FIG. 10. As best shown in FIG. 10, the indent 270 formed in the exterior surface 216 of the walled container 212 has a concave shape. However, in other examples, the indent 270 may be a different shape arranged so that the expandable grip accessory 220 can sit flush with the walled container 212 and provide room for a user to grip the button 228 and move the expandable grip accessory 220. A second end 226 of a grip accessory body 222 is operatively coupled to the walled container 212, and is specifically coupled to a hub 240, as shown in FIG. 12. The second end 226 of the grip accessory body 222 may rotatably couple, slidably couple, or connect by a different suitable mechanism to the hub 240.

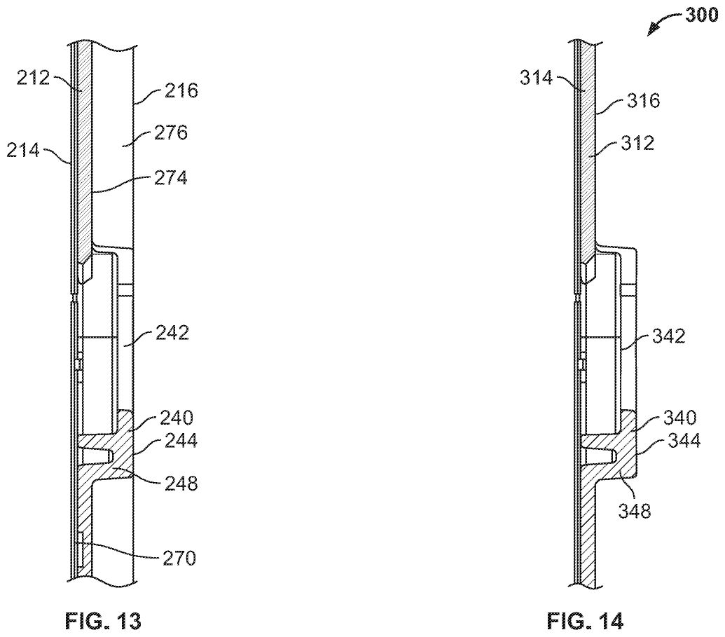

The cross-sectional view of the container assembly of FIG. 12 depicts the expandable grip accessory 220 in the collapsed configuration and operatively coupled to the walled container 212. However, any one of the container assemblies of FIGS. 12-16 may include a sleeve or other walled container, such as the sleeve 232 of the container assemblies 230 of FIG. 11. For simplicity, the cross-section is a side view of the third exemplary container assembly 210 of FIGS. 8-10. The indent 270 is recessed below the exterior surface 216 of the walled container 212 and is deep enough to hold the collapsed grip accessory body 222 of the expandable grip accessory 220 without substantially increasing the thickness of the walled container 212. As shown in FIG. 13, the hub 240 is integrally formed with the walled container 212 and a collar 248 of the hub 240 extends away from a surface 274 of the indent 270. The side opening 242 formed in the collar 248 is sized to slidably receive the second end 226 of the grip accessory body 222. The indent 270 provides a space 276 surrounding the hub 240 so that a user may easily slide the second end 226 of the grip accessory body 222 into the opening 242 of the hub 240. When the expandable grip accessory 220 is coupled to the hub 240, the space 276 surrounding the indent 270 also surrounds the expandable grip accessory 220 and facilitates moving the expandable grip accessory 220 between the collapsed and extended configuration. The button 228 of the expandable grip accessory 220 extends slightly beyond the exterior surface 216 of the walled container 212, but does not rest against the exterior surface 216. In a fourth exemplary container assembly 300 shown in FIG. 14, an integrated hub 340 is not surrounded by an indent. Rather, a collar 348 of the hub 340 extends outwardly from an exterior surface 316 of a walled container 312.

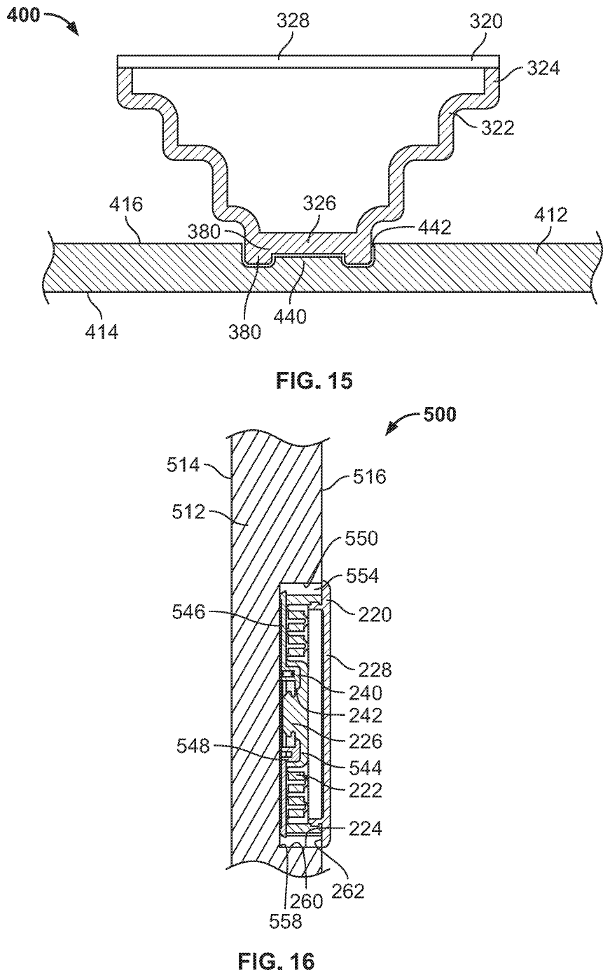

The cross-sectional view of the container assembly of FIG. 12 depicts the expandable grip accessory 220 operatively coupled to the walled container 212. However, any one of the previously described container assemblies 210 and 300 of FIGS. 12-14 and following container assemblies of FIGS. 15 and 16 may include a sleeve, such as the sleeve 232 of FIG. 11 or other walled container.

In FIG. 15, a hub 440 of a fifth exemplary container assembly 440 is completely embedded within a walled container 412, and a fourth exemplary expandable grip accessory 320 is operatively coupled to the walled container 412 by removable connection with the hub 440. In this example, the hub 440 is disposed below an exterior surface 416 of the walled container 412 and does not provide a collar extending outwardly to receive a grip accessory body. The hub 440 instead includes a female key 442 that receives a male snap-fit connector 380 disposed at a second end 326 of a grip accessory body 322. The female key 442 facilitates aligning and mating the expandable grip accessory 320 with the walled container 412. The opening 442 of the female key 442 is disposed below the exterior surface 416 and above an interior surface 414 of the walled container 412. In another example, the grip accessory body 322 may operatively connect to the walled container 412 by rotatably connecting the grip accessory body 322 to the hub 440. In either example, the grip accessory body 322 lays against the exterior surface 416 of the walled container 412 when the expandable grip accessory 320 is in the collapsed configuration.

In FIG. 16, a sixth exemplary container assembly 500 is assembled in accordance with the teachings of the present disclosure, and includes the third exemplary expandable grip accessory 220. A hub 540 is at least partially embedded within a walled container 512 such that a portion of the hub 540 is disposed between an interior surface 514 and an exterior surface 516 of the walled container 512. The hub 540 may be integrally formed with the walled container 512 and disposed within a recessed area 554 formed in the exterior surface 516. In another example, the hub 540 may be formed separately and subsequently attached to the walled container 512 within the recessed area 554.

In FIG. 17, a seventh exemplary container assembly 630 is assembled in accordance with the teachings of the present disclosure. The container assembly 630 includes the walled container 12 and expandable grip accessory 20 of the container assembly 10 of FIG. 1, for example, disposed within a cavity 638 defined by a sleeve 632. The sleeve 632 is much like any one of the sleeves 32, 132 and 232 of the previous examples, and includes an outer surface 636 and an inner surface 634, which at least partially defines the cavity 638. The sleeve 632 includes an aperture 650 formed through both the inner surface 634 and the outer surface 636. In this example, the second end 26 of the expandable grip accessory 20 is disposed through the aperture 650 of the sleeve 632 and operatively couples to the walled container 12. The assembly 630 of FIG. 17 may be assembled by sliding the container assembly 10 into the cavity 638 of the sleeve 632 so that the expandable grip accessory 20 is aligned with the aperture 650 of the sleeve 632. The expandable grip accessory 20 may be pushed through the aperture 650, or the expandable grip accessory 20 may couple to the walled container 12 through the sleeve 632 after the walled container 12 is disposed within the sleeve 132. Once assembled, the exterior surface 16 of the walled container 12 is adjacent the inner surface 634 of the sleeve 632 and the expandable grip accessory 20 is disposed within a stepped profile 652 of the aperture 650 formed in the outer surface 636 of the sleeve 632.

Any of the sleeves 32, 132, 232, and 632 of the container assemblies 30, 130, 230, and 630 of FIGS. 3, 4, 6, 8, and 17 may be configured to open at a pivot, e.g. a joint, a hinge, etc., to wrap around a beverage container. For example, FIG. 18 illustrates an eighth exemplary container assembly 730 constructed in accordance with the teachings of the present disclosure. A walled container 732 includes a first half 782 and a second half 784 joined and movable by a hinge 786. The hinge 786 permits the walled container 732 to open, as shown in FIG. 18, to receive a beverage container. Each half 782, 784 of the sleeve 732 defines in part a cavity 788, 790, respectively, and together the cavities 788, 790 of each half 782, 784 forms a cavity 738 of the sleeve 732. A user may slide a beverage container into the cavity 738 of the sleeve 732 when the first half 782 and the second half 784 are closed, as shown, for example, in FIGS. 3, 4, 6, 8, and 17. A user may also insert the beverage container in one of the cavities 788, 790 or between the cavities 788, 790 of the first and second halves 782, 784 before closing the walled container 732 around the beverage container. In the illustrated embodiment, each half 782, 784 closes to hold a particular shaped beverage container. However, in other examples, the hinge 786 may be configured to permit each half 782, 784 to rotate beyond the closed position such that an interior surface 734 of one half 782, 784 overlaps with an outer surface 736 of the other half 784, 782, effectively shrinking the size of the cavity 738 of the sleeve 732. Thus, the sleeve 732 may be compatible with different sized beverage containers. The third exemplary expandable grip accessory 220 is operatively coupled to the first half 782 of the sleeve 732. In other examples, any of the first, second, third, and fourth exemplary expandable grip accessorys 20, 120, 220, 320 may be coupled to the first half 782, the second half 784, or in between the first and second halves 782, 784.

In the example of FIG. 19, a ninth exemplary container assembly 830 is constructed in accordance with the teachings of the present disclosure. A sleeve 832 of the ninth exemplary container assembly 830 is similar to the sleeve 732 of the eighth exemplary container assembly 730 of FIG. 18 described above, except that the ninth exemplary container assembly 830 is particularly suited to wrap around a stemmed walled container, such as a wine glass 812. Elements of the container assembly 830 in FIG. 19 which are similar to the elements of the container assembly 730 of FIG. 18 are designated by the same reference numeral, incremented by 100. A description of many of these elements is abbreviated or even eliminated in the interest of brevity.

In the exemplary arrangement of the container assembly 830 of FIG. 19, the walled container 832 is a hinged sleeve 832, and is operatively coupled to a fifth exemplary expandable grip accessory 420. The sleeve 832 is sized to receive a narrow stem 894 of the wine glass 812, and includes a hinge 836 to permit the sleeve 832 to open and close around the stem 894. The sleeve 832 is a circular band formed by a first half 882 and a second half 884, where the first half 882 is operatively coupled to the expandable grip accessory 420. A hub 840 extends from an outer surface 836 of the sleeve 832 to removably couple to a second end 426 of the expandable grip accessory 420. In other examples, the expandable grip accessory 420 may couple to the sleeve 832 in a different configuration, and the sleeve 832 may be larger, providing a wider support surface for the expandable grip accessory 420 when the expandable grip accessory is in a collapsed configuration.

In a tenth exemplary container assembly 910 of FIG. 20, a walled container 912 may include a pocket 996 sized to hold a portable media player 998 with an attached expandable grip accessory 920. The expandable grip accessory 920 extends through an opening in the pocket 996 so that a user may grip the walled container 912 by holding their portable media player. In this way, the walled container 912 is operatively coupled to the expandable grip accessory 920 by way of the integrated pocket 920 holding the portable media player.

The container assemblies 10, 30, 130, 210, 230, 300, 400, 500, 630, 730, 830, and 910 of FIGS. 1-20 are exemplary and may be arranged differently to achieve the same or similar function. For example, a walled container according to the teachings of this disclosure may be customized to a desired shape and to adaptively couple to a variety of different expandable grip accessorys. The walled container may include a different shaped indent or recessed area to receive the expandable grip accessory and may include a different coupling mechanism to operatively connect with a grip accessory body of an expandable grip accessory. The expandable grip accessorys may be permanently secured to the walled containers, or the expandable grip accessorys may be removably coupled to the walled containers such that a grip accessory body may be switched out a container assembly with another grip accessory body for a different use, function, and/or design.

Each of the container assemblies 10, 30, 130, 210, 230, 300, 400, 500, 630, 730, 830, 910 may improve grip on any beverage container and may also creatively identify the owner or user of the beverage container. The button of each expandable grip accessory may provide a logo, design, trademark, slogan, mascot, name, or other graphic that identifies a company name, sponsor, personal identification, favorite sports team, artistic design, or other visual display. In one example, a runner may display the name of their sponsor on a walled container (e.g. a water bottle) and/or button of a container assembly that the runner uses while running. In another example, a party guest may mark their wine glass before setting it down by attaching a unique container assembly, such as the container assembly 830 of FIG. 19, to the stem of the wine glass. In a different setting, a tailgate host may provide a number of container assembly koozies with a team's mascot, player number, or other marking for their guests.

The figures and description provided herein depict and describe preferred examples of a container assembly or sleeve for purposes of illustration only. One skilled in the art will readily recognize from the foregoing discussion that alternative examples of the components illustrated herein may be employed without departing from the principles described herein. Thus, upon reading this disclosure, those of skill in the art will appreciate still additional alternative structural and functional designs for a container assembly or sleeve. Thus, while particular examples and applications have been illustrated and described, it is to be understood that the disclosed examples are not limited to the precise construction and components disclosed herein. Various modifications, changes and variations, which will be apparent to those skilled in the art, may be made in the arrangement, operation and details of the methods and components disclosed herein without departing from the spirit and scope defined in the appended claims.

1-27. (canceled)

28. A container assembly for holding a beverage, the assembly comprising:
a walled container including an interior surface and an exterior surface, the interior surface at least partially defining a reservoir for holding (a) a liquid or (b) a container for holding a liquid;
an expandable grip accessory operatively coupled to the walled container, the expandable grip accessory including a grip accessory body movable between an extended configuration and a collapsed configuration, the grip accessory body including a first end and a second end; and
wherein the first end of the grip accessory body is spaced away from the exterior surface of the walled container when the grip accessory body is in the extended configuration.

29. The assembly of claim 28, further comprising a hub operatively coupled to the walled container, the hub including an opening sized to receive at least a portion of the second end of the grip accessory body, wherein the second end of the grip accessory body is removably coupled to the hub.

30. The assembly of claim 29, wherein the hub includes a first surface and a second surface, the first surface defining the opening and the second surface deformable to fit against the exterior surface of the walled container.

31. The assembly of claim 30, wherein the second surface is curved to conform to the exterior surface of the walled container.

32. The assembly of claim 28, wherein the hub is removably attached to the exterior surface of the walled container.

33. The assembly of claim 28, further comprising an indentation formed in the exterior surface of the walled container, the indentation sized to receive at least a portion of the expandable grip accessory.

34. The assembly of claim 29, wherein the hub is at least partially embedded within the walled container such that a portion of the hub is disposed between the interior surface and the exterior surface of the walled container.

35. The assembly of claim 29, wherein the hub is integrally formed with the exterior surface of the walled container.

36. The assembly of claim 29, further comprising a sleeve operatively connected to the hub, the sleeve including an outer surface, an inner surface, and a cavity at least partially defined by the inner surface, the cavity sized to receive at least a portion of the walled container.

37. The assembly of claim 36, further comprising an aperture extending through the outer surface and inner surface of the sleeve, the aperture sized to receive at least a portion of the grip accessory body.

38. The assembly of claim 37, wherein the hub is disposed between the exterior surface of the walled container and the inner surface of the sleeve.

39. The assembly of claim 37, wherein the aperture of the sleeve defines a stepped profile to receive the grip accessory body when the expandable grip accessory is in the collapsed configuration.

40. The assembly of claim 36, wherein the hub is integrally formed with the outer surface of the sleeve.

41. The assembly of claim 29, wherein the hub couples to the second end of the grip accessory body by snap fit connection.

42. The assembly of claim 29, wherein the walled container is a cylindrical sleeve.

43. The assembly of claim 42, wherein the grip accessory body extends through an aperture formed in the sleeve and the hub includes a first surface forming the opening and a second surface, a portion of the first surface adjacent to the interior surface of the sleeve.

44. A sleeve for holding a beverage container, the sleeve comprising:
a body having a cavity, a longitudinal axis, a first surface, and a second surface, the first surface at least partially defining the cavity;
an expandable grip accessory operatively coupled to the body, the expandable grip accessory including a grip accessory body movable between an extended configuration and a collapsed configuration;
wherein the grip accessory body is expandable in a direction substantially perpendicular relative to the longitudinal axis of the body.

45. The sleeve of claim 44, further comprising a hub operatively coupled to the grip accessory body and the grip accessory body including a second end, the hub including an opening sized to receive at least a portion of the second end of the grip accessory body.

46. The sleeve of claim 45, wherein the hub includes a first surface and a second surface, the first surface defining the opening and the second surface having a radius of curvature sized substantially similar to a radius of curvature of the first surface of the body.

47. The sleeve of claim 45, wherein the hub is at least partially embedded within the body such that a portion of the hub is disposed between the first surface and the second surface of the body.

48. The sleeve of claim 46, wherein the hub is removably attached to the body.

49. The sleeve of claim 45, wherein the hub is integrally formed with the body.

50. The sleeve of claim 45, wherein the body includes an aperture formed through the first surface and the second surface of the body, the hub disposed within the cavity and extends at least partially through the aperture.

51. The sleeve of claim 45, wherein the hub couples to the expandable grip accessory by snap fit connection.

52. The sleeve of claim 44, wherein the body includes an indentation formed in the second surface and sized to receive at least a portion of the grip accessory body.

53. The sleeve of claim 44, wherein the body includes a first half, a second half, and a hinge pivotably connecting the first half and the second half.

54. The sleeve of claim 44, wherein the body is cylindrical.
